(19) United States
(12) Patent Application Publication
(10) Pub. No.: US 2006/0212369 A1
(43) Pub. Date: Sep. 21, 2006

(54) Multiple dimension closings

(75) Inventors: Kimberly Ann Nelson, Fargo, ND (US); Brett M. Lindemann, Fargo, ND (US); Donald D. Nelson, Moorhead, MN (US); Ronald H. Schulz, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/080,784

(22) Filed: Mar. 15, 2005

(51) Int. Cl. G06F 17/60

(52) U.S. Cl. 705/28

(57) ABSTRACT

A computer implemented accounting system is provided facilitating multiple-dimension closings. A plurality of user-definable transaction dimensions can be selected as closing dimensions. Then, when a given accounting period is to be closed, closing journal entry lines and offsetting lines related to all unique combinations of closing dimensions are generated.

### BACKGROUND OF THE INVENTION

The present invention generally pertains to software applications that facilitate tracking corporate finances.

Modern business solutions software provides businesses with a vast array of powerful tools. Such solutions are known to provide integrated capabilities for financial management, distribution, manufacturing, project accounting, human resource management, field service management, and business analytics. Within such solutions, one aspect often provides automated business accounting functions.

Whether provided as a module in an integrated business solutions application, or as a stand-alone system, corporate accounting is configured to support conformance with some level of standardized accounting practices. Such software supports the use of balance sheets that provide a snapshot of a business' financial condition at a specific moment in time, usually at the close of an accounting period. Most accounting software also includes revenue, expense, and/or capital withdrawal accounts in the form of temporary accounts that are reset at the end of an accounting period so that they will have zero balances at the start of the next period.

Periodically, a business will close an accounting period and generate one or more standard accounting documents in order to allow the business, and/or others to assess how well the business is running. The closing process allows a vast amount of information to be significantly distilled such that all temporary account information is closed out to one or more retained earnings accounts. While this is extremely useful for many businesses, it has limited utility for large or complex business enterprises. Specifically, many enterprises break out their business units into profit centers and cost centers. A business unit that is defined as a profit center is typically run as its own business. It has revenues and costs associated to those revenues. The goal of a profit center is to make a profit. On the other hand, a cost center does not earn revenue and does not have a goal to make a profit. A human resources department would be one example of a cost center. Thus, even though these business units are run as their own companies, the requirement that business solution software must meet the needs of the overall enterprise has limited the ability to provide business analytics at the sub-business unit level.

Accordingly, an accounting system that could address the accounting needs of business units while continuing to provide critical accounting functions to an overall enterprise would be a significant improvement to the art.

### SUMMARY OF THE INVENTION

A computer implemented accounting system is provided facilitating multiple-dimension closings. A plurality of user-definable transaction dimensions can be selected as closing dimensions. Then, when a given accounting period is to be closed, closing journal entry lines and offsetting lines related to all unique combinations of closing dimensions are generated.

### BRIEF DESCRIPTION OF THE DRAWINGS

FIG. 1 is a block diagram of a computing environment in which embodiments of the present invention may be implemented.

FIG. 2 is a schematic block diagram of a simplified financial record system.

FIG. 3 is a table illustrating a number of transactions tracked using a number of dimensions.

FIG. 4 is a flow diagram of a method of closing to multiple dimensions in accordance with an embodiment of the present invention.

FIG. 5 is a table illustrating closing journal entries generated in accordance with an embodiment of the present invention.

FIG. 6 is a table illustrating Balance Brought Forward (BBF) entries generated during closing in accordance with embodiments of the present invention.

### DETAILED DESCRIPTION OF ILLUSTRATIVE EMBODIMENTS

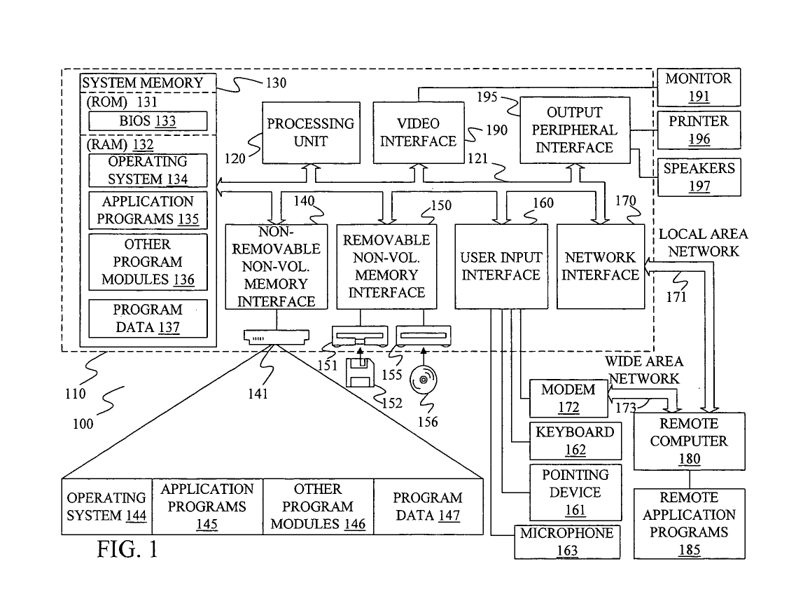

FIG. 1 illustrates an example of a suitable computing system environment 100 in which embodiments of the present invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

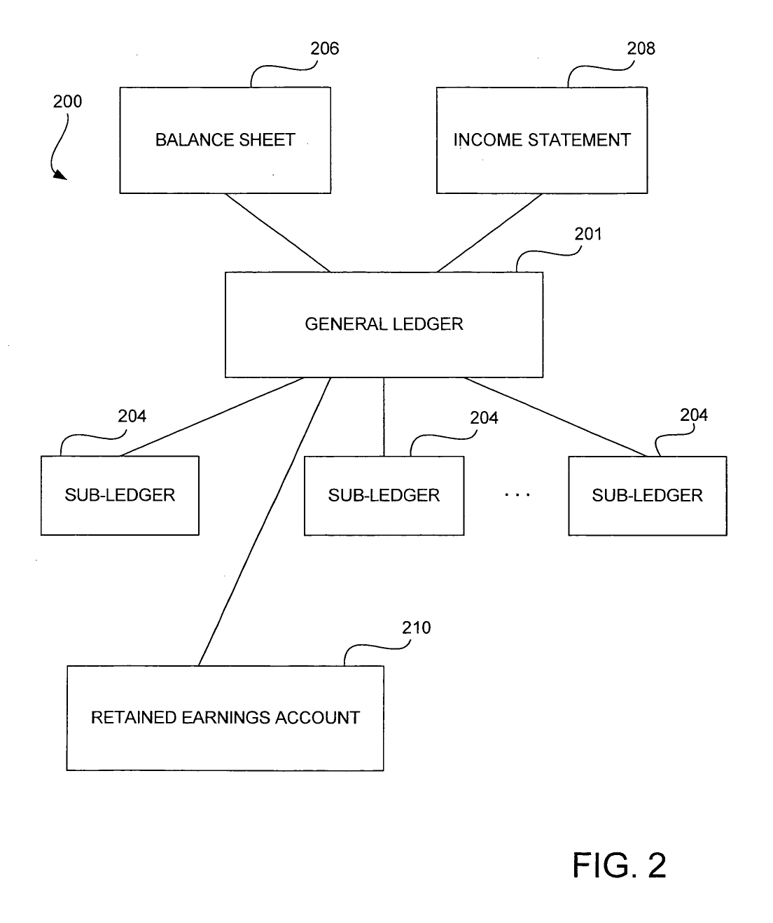

FIG. 2 is a schematic block diagram of a simplified financial record system 200 that represents one context within which embodiments of the present invention can be implemented. The core of system 200 is general ledger 201. All financial transactions flow through general ledger 201 so as to support the creation of a permanent financial history.

System 200 also includes a plurality of sub-ledgers 204 that track specific items such as cash, accounts receivable, accounts payable, payroll, inventory and the like. All entries posted to sub-ledgers 204 will transact through general ledger 201. For example, when a customer pays off a bill with cash, the transaction will be posted to the general ledger and the two appropriate sub-ledgers 204 (i.e., cash and accounts receivable).

Balance sheet 206 and income statement (sometime referred to as a “profit and loss” statement) 208 are financial documents that are drawn directly from general ledger 201. More specifically, general ledger 201 will contain the balances that make up line items on reports 206 and 208.

Balance sheet 206 is typically configured to provide an overview of financial condition at a given point in time such as at the close of an accounting period. The overview generally includes at least assets (anything the business owns) and liabilities (claims of creditors against assets of the business). In contrast, income statement 208 provides a profit/loss summary during a predetermined period of time, such as a month, quarter or one-year. The summary will generally include revenues and operating expenses for the business during the relevant time period.

It is common for system 200 to be implemented in the specific context of a software application. It should be noted that, for the purpose of illustrating basic components, system 200 is very simply presented. When actually applied in the context of real-world businesses, the structure of such a system can become quite complex, particularly when applied in the context of a large company having a sophisticated enterprise-oriented organization scheme.

Generally accounting software helps a business to conform with standardized accounting practices. Most applications include reporting functionality in the form of support for balance sheets and/or income statements. In addition, most applications also include revenue, expense, and/or capital withdrawal accounts in the form of temporary accounts that are reset at the end of an accounting period so that they will have zero balances at the start of the next period (commonly one year). Closing entries are the journal entries used to transfer balances of temporary accounts to permanent accounts. After the closing entries have been made, the temporary account balances will be reflected in a more permanent account such as a retained earnings account. A retained earnings account 210 is indicated in FIG. 2.

Embodiments of the present invention provide significantly improved business analytics for business units as well as a business enterprise. Embodiments of the present invention generally employ the use of user-definable transaction dimensions. A user-definable transaction dimension is similar to a variable that contains additional information relative to a transaction. These user-definable transaction dimensions are used to classify, report, and analyze financial transactions based upon a user's specific business needs. The number of transaction dimensions that can be defined by a user are essentially unlimited and include such dimensions as cost center, profit center, region, and hours, as well as predefined system transaction dimensions such as customer, vendor, item, and site. These user-defined transaction dimension codes are then attached to ledger transactions which eliminates the need to analyze transactions on the basis of account segments. Once a given transaction dimension is defined, the user selects whether the transaction dimension is a closing dimension. Thus, embodiments of the present invention now provide the ability to define multiple dimensions as closing dimensions as well as the ability to define a specific dimension code(s) to close in combination with the retained earnings account. In the past, enterprise resource planning systems that have supported a closing dimension have only supported the ability to define one closing dimension.

In distinct contrast, users of systems embodying the present invention are able to select to close their revenue and expense accounts to one retained earnings account or to close to one or more dimensions. Dimensions can be selected as closing dimensions, or a specific dimension can be entered in combination with the retained earnings account. The closing process (which will be described in greater detail below) creates a closing journal entry that will move the balance for each unique closing dimension combination from the revenue and expense account/dimension combination to the retained earnings fully qualified account (account and dimension combination). The closing process also brings forward any balances for the balance sheet accounts.

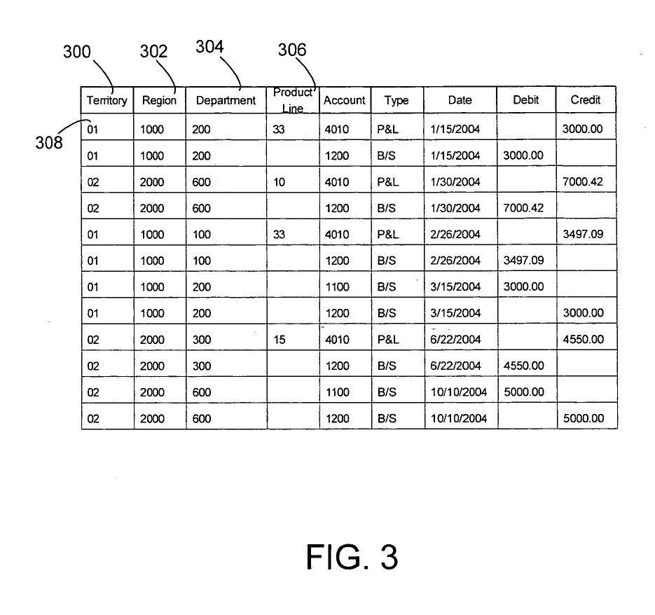

FIG. 3 is a table of journal entries illustrating the use of transaction dimensions. Specifically, the user has selected or otherwise defined four distinct dimensions illustrated in FIG. 3. Territory 300, region 302, department 304, and product line 306 are all user defined transaction dimensions illustrated in FIG. 3. A given general ledger transaction 308 is then augmented with information, to the extent known, relative to the dimensions. For example, transaction 308 is augmented with territory information indicating that the transaction is related to territory 01, region information indicating region 1000, department information indicating department 200, and product information indicating product line 33. Additionally, each transaction transacts relative to a selected account and the type of that account is listed, whether it be a profit and loss account (P&L) or a balance sheet (B/S) account.

In accordance with an embodiment of the present invention, a user may have defined transaction dimensions region 302 and department 304 as closing dimensions, and account 3300 as the retained earnings account with territory 00. When the user desires to close a given accounting period (such as FY 2004) the accounting system will generate two types of transactions in the closing process. The closing transaction closes the activity for all profit and loss accounts into the retained earnings account in combination with any closing dimensions. The balance brought forward (BBF) transaction then brings the balances forward into the new accounting period for all balance sheet accounts. Each transaction will have a unique journal number generated during the closing process.

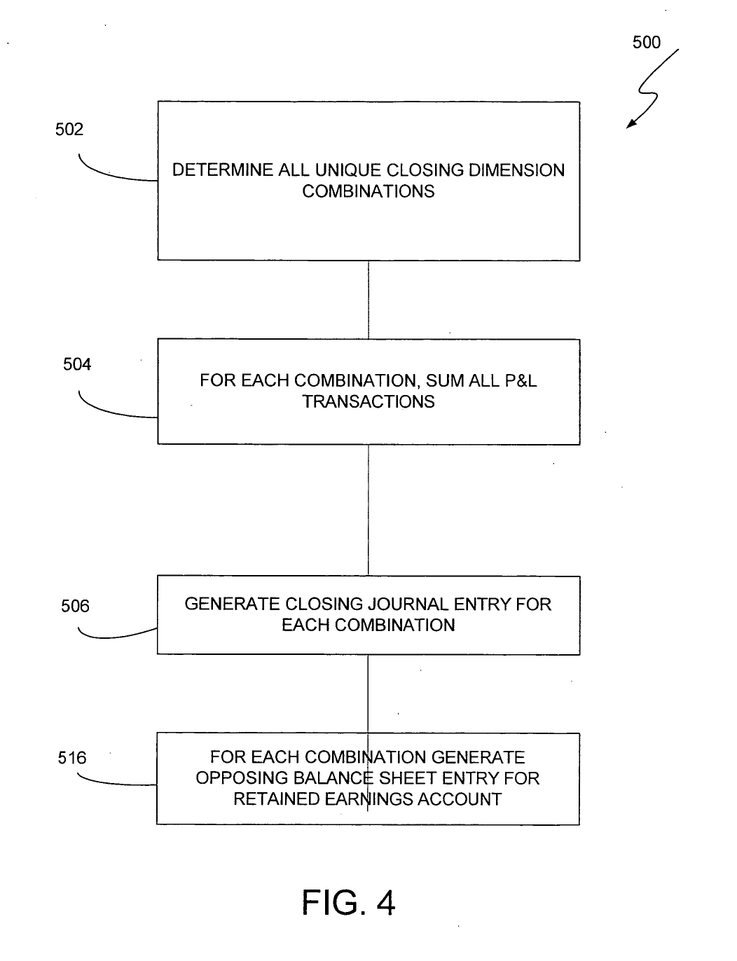

FIG. 4 is a diagrammatic view of a method for closing to multiple dimensions in accordance with an embodiment of the present invention. Method 500 begins at block 502 where the accounting system scans all transactions for the selected accounting period to determine all unique combinations of closing dimensions. In the table illustrated in FIG. 3, there are four such combinations (region 1000, department 200; region 1000, department 100; region 2000, department. 300; and region 2000, department 600). Accordingly, this process can become quite extensive relatively quickly based on the number of closing dimensions and unique dimension values within those closing dimensions. In some embodiments, the user may select to close to a specific dimension code in combination with the retained earnings account. In such cases, all unique combinations of the single dimension and retained earning account are identified.

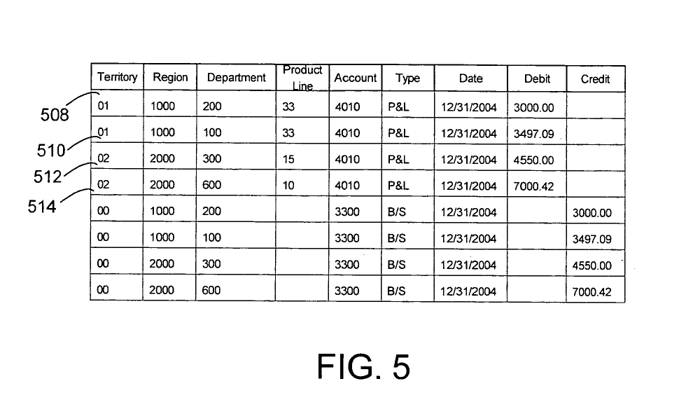

At block 504, the accounting system will add all profit and loss transactions for each unique combination of closing dimensions together. For example, all general ledger transactions for region 1000, department 200 will be summed together. Once the sums have been computed, closing journal entries are generated at block 506. These closing journal entry lines are illustrated in FIG. 5, at lines 508, 510, 512, and 514. At block 516, closing balance sheet entries are generated to retained earnings account 3300 in order to directly oppose the profit and loss closing entries. In order to be correct, the balance sheet entries completely offset all profit and loss entries such that the profit and loss accounts can be zeroed going into the next accounting period.

The result of method 500 is a tiered closing process that generates two types of transactions. The first type of closing transactions is illustrated in FIG. 5 as a closing journal entry. This entry ensures that the activity for all temporary accounts, such as a P&L account, are closed in to the retained earnings account (in this example 3300) with any closing dimensions.

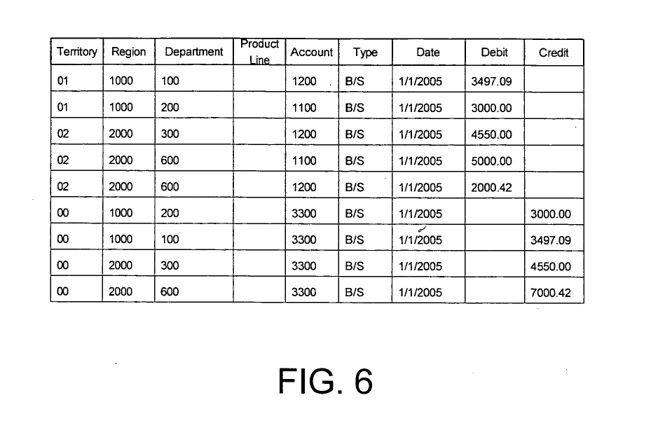

The second type of transactions is illustrated in FIG. 6 as Balance Brought Forward (BBF) entries that are generated to bring the balances forward into the new accounting period for all B/S accounts. FIG. 5 represents a single multi-line journal entry with a unique journal number. FIG. 6 represents a single multi-line journal entry with a unique journal number.

Embodiments of the present invention allow user-defined business units to be essentially closed while ensuring that the overall closing operation is still valid for the enterprise itself. Thus, a given business unit can see whether it was profitable or not. This allows an enterprise to have significant visibility into its own internal units to identify units that are particularly profitable or not. Further, these features are provided in a manner that is intuitive for users to understand and easy for them to adopt.

Although the present invention has been described with reference to particular embodiments, workers skilled in the art will recognize that changes may be made in form and detail without departing from the spirit and scope of the invention.

What is claimed is:

1. A computer-implemented accounting method comprising:
storing transactions with a plurality of user-defined transaction dimensions;
selecting a plurality of user-defined transaction dimensions as closing dimensions;
identifying unique combinations of closing dimension values; and
generating a closing journal entry for each unique combination.

2. The method of claim 1, wherein identifying unique combinations of closing dimension values includes identifying all unique combinations of closing dimension values.

3. The method of claim 1, wherein generating a closing journal entry for each unique combination includes summing all stored transactions having the unique combination.

4. A computer-implemented accounting method comprising:
storing transactions with a plurality of user-defined transaction dimensions;
selecting a user-defined transaction dimension as a closing dimension in combination with a retained earnings account;
identifying unique combinations of closing dimension values and retained earnings account values; and
generating a closing journal entry line and offsetting line for each unique combination.

5. A computer implemented accounting method comprising:
defining a plurality of transaction dimensions; and
selecting at least one of the plurality of transaction dimensions as a closing dimension.

6. The method of claim 5, and further comprising closing to at least one closing dimension.

7. The method of claim 6, wherein closing includes identifying unique combinations of closing dimension values in a plurality of transactions.

8. The method of claim 7, wherein all transactions having the same unique combination are summed.

9. The method of claim 8, wherein a journal entry line and offsetting line is generated for each unique combination.

10. The method of claim 9, wherein each journal entry is given a unique journal number.

11. The method of claim 6, wherein the closing closes all temporary accounts into a permanent account.

12. The method of claim 11, wherein the temporary account is a Profit and Loss (P&L) account.

13. The method of claim 11, wherein the permanent account is a balance sheet account.
